(19) United States
(12) Patent Application Publication
(10) Pub. No.: US 2007/0000941 A1
(43) Pub. Date: Jan. 4, 2007

(54) Motion-activated soap dispenser

(76) Inventors: David M. Hadden, Los Altos, CA (US); Gregory B. Gabriel, Los Altos, CA (US); Stephen J. Blumenkranz, Redwood City, CA (US)

Correspondence Address: ROGITZ & ASSOCIATES, 750 B STREET, SUITE 3120, SAN DIEGO, CA, 92101, US

(21) Appl. No.: 11/173,573

(22) Filed: Jul. 1, 2005

(51) Int. Cl. B67D 5/08; G01F 11/20

(52) U.S. Cl. 222/52; 222/333; 222/63; 222/412

(57) ABSTRACT

A cap member that can be threadably engaged with a conventional soap bottle contains a battery-powered PIR motion detector and a motor responsive to the detector to dispense soap when a hand is sensed nearby.

### FIELD OF THE INVENTION

The present invention relates generally to motion-activated household liquid dispensers such as soap dispensers and toothpaste dispensers.

### BACKGROUND OF THE INVENTION

Soap dispensers that have motion detectors for sensing a nearby hand and emitting a stream of liquid soap in response are known. As critically recognized herein, however, existing dispensers typically must be installed in or on a sink surface, consuming time and requiring at least rudimentary handyman skills. Further, existing dispensers ordinarily are sold with their own specially configured soap containers. The present invention critically recognizes the desirability of retrofitting existing manual pump-type dispensers with motion-sensing automatic dispenser units, an application for which, for the above reasons, existing dispensers are inappropriate or inadequate.

Additionally, for reasons of convenience and ease of installation regardless of retrofitting, the present invention recognizes the advantages of using battery power for automatic soap dispensers. Connecting the electrical components of automatic dispensers to the ac power grid requires electrician expertise. As critically understood herein, however, motion sensors that have been used in automatic dispensers consume relatively large amounts of power, on the order of hundreds of micro amps on average, which can rapidly drain batteries and thus require larger batteries or frequent battery replacement should battery power be used. With the above drawbacks in mind, the solutions to one or more them are provided herein.

### SUMMARY OF THE INVENTION

An automatic soap dispensing system includes a hollow housing that is configured for threadably engaging a soap container. The container for which the housing is configured advantageously may be a container that is originally associated with a manual pump mechanism for expelling soap. The housing contains at least one battery and a motion detector powered by the battery. The detector may be on the housing. Also, a motorized pump assembly is in the housing and is powered by the battery. The pump assembly expels soap from the container in response to signals from the motion detector.

The motion detector may be a passive infrared (PIR) detector that never consumes more than fifty micro amperes on average, and more preferably twenty micro amperes on average and that more preferably still consumes only ten to fifteen micro amperes or less on average.

In non-limiting embodiments the pump assembly includes an outlet passage and an orifice in the outlet passage. The pump assembly can also include an uptake tube extending into the container when the housing is engaged with the container, with the uptake tube including a one-way valve disposed inside it. It should be noted that a one-way valve can be located anywhere in the flow stream including acting as a one-way valve orifice combination on the end of the outlet passage.

In one implementation, the pump assembly includes a screw pump member rotating to draw up substance along the threads of the screw pump from the uptake tube to urge the substance into the outlet passage. Or, the pump assembly may include a gear pump. Yet again, the pump assembly may include a rotatable lead screw and a piston reciprocatingly engaged therewith for linear motion when the lead screw rotates. In this latter implementation, the pump assembly moves between a ready configuration, wherein no motion signal is received and the piston is detached from the lead screw and compresses a return spring, and a delivery configuration, wherein the piston is engaged with the lead screw. The presence of a motion signal when in the ready configuration causes the lead screw to rotate, with the return spring urging the piston into engagement with the lead screw as it rotates for movement to the delivery configuration.

In another aspect, an automatic substance-dispensing system includes a hollow housing configured for removably engaging a substance container and at least one battery in the housing. A PIR motion detector is in the housing and is powered by the battery. The motion detector never consumes more than fifty micro amperes on average, and more preferably twenty micro amperes on average. A motorized pump assembly is in the housing and is powered by the battery to expel substance from the container in response to signals from the motion detector.

In still another aspect, a method includes disposing a motion detector and a motorized pump in a housing. The method includes removing a manual pump mechanism from a substance container and engaging the housing with the container. The method then includes activating the pump in response to signals from the motion detector to expel substance from the container.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a perspective view of the present automatic soap dispenser, shown in an exploded relationship with a conventional liquid soap container along with the preexisting, manual pump member that is originally associated with the container;

FIG. 2 is a cut-away perspective view of a first embodiment that uses a screw pump, in operable engagement with the soap container;

FIG. 3 is a cut-away perspective view of a second embodiment that uses a gear pump, with the soap container and uptake tube omitted for clarity;

FIG. 4 is a cross-sectional elevational view of a third embodiment that uses a lead screw with reciprocating plunger and piston, in the ready configuration, with the soap container omitted for clarity;

FIG. 5 is a cross-sectional elevational view of the third embodiment in the delivery configuration;

FIG. 6 is a close-up view of the dispenser in the configuration shown in FIG. 4, showing the fingers of the return spring compressed by engagement with the piston;

FIG. 7 is a close-up view of the dispenser in the configuration shown in FIG. 5, showing the fingers of the return spring relaxed after urging the plunger into threaded engagement with the lead screw;

FIG. 8 is a close-up view of the head portion of the device shown in FIGS. 4-7; and

FIG. 9 is a flow chart showing the operation of the dispenser.

### DETAILED DESCRIPTION OF THE PREFERRED EMBODIMENT

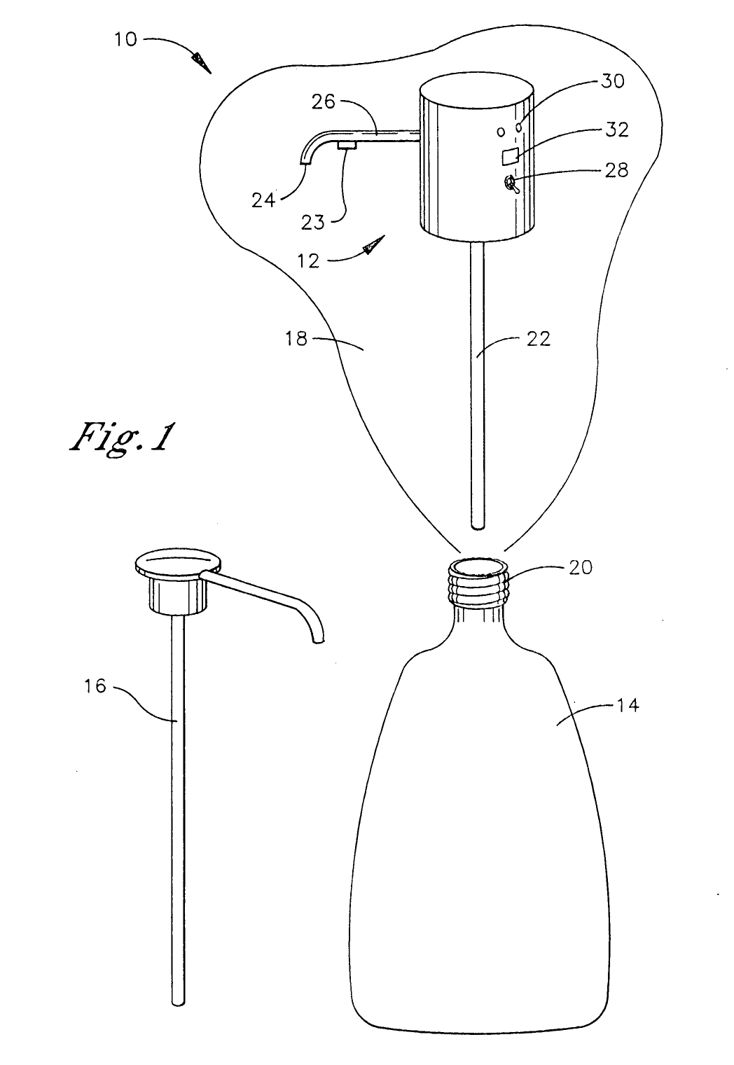

Referring initially to FIG. 1, a system is shown, generally designated 10, which includes a hollow metal or plastic housing 12 that is configured for threadably engaging a substance container, such as a liquid soap container 14, or a toothpaste container, or a mouthwash container, or hand cream container, or other flowable hygienic substance container. The container 14 for which the housing 12 is configured is a container that is originally associated with a manual pump mechanism 16 as shown for expelling substance such as soap therefrom. Since the housing 12 in one aspect is intended to engage the pre-existing container 14, the housing 12 can be provided in a kit 18 that need not include a container or the substance to be expelled from the container.

In the embodiment shown the housing 12 is cylindrical and as further disclosed below is configured to threadably engage threads 20 on the container 14. The housing 12 may take other shapes, e.g., it may be parallel-piped-shaped or it may be oval in cross-section. In other implementations the housing 12 may snap onto the container 14 or be removably engaged with the container 14 by other means known in the art.

As shown in FIG. 1, an uptake tube 22 extends into the container 14 when the housing 12 is engaged with the container 14. The below-disclosed motorized pump, which is activated by signals from a motion detector that includes a sensor 23, draws substance from the container 14 up the uptake tube 20 and expels the substance out of a downwardly-oriented end 24 of an outlet passage that can be formed by a horizontally-oriented outlet tube 26. As also disclosed below, one or more batteries are in the housing 12 to power the motor-driven pump and the motion detector.

The motion sensor 23 may be an ultrasonic motion detector or other motion detector such as an active infrared sensor, but in the preferred embodiment it is a passive infrared (PIR) detector which never consumes more than about fifty micro amperes on average, and more preferably consumes less than twenty micro amperes on average. The motion sensor 23 with accompanying detector system within the housing 12 may be any one of the passive infrared (PIR) systems disclosed in the following published U.S. patent applications, all of which are incorporated herein by reference: 20050016283, 20040189149, 20040169145, 20040164647, 20040140430, which advantageously operate on less than fifteen micro amperes on average and as low as ten micro amperes on avaerage.

In non-limiting embodiments various user controls and indications may be provided on the housing 12. By way of non-limiting example, a manual on-off switch 28 can be provided to activate and deactivate the motor and motion detector. If desired, an indicator lamp such as, e.g., an LED 30 can be controlled to blink or otherwise indicate when it is about time to replace the batteries. A cycle lamp 32 may also be provided to indicate operational status of the system 10, e.g., to indicate when the motor-driven pump is actively discharging soap from the container 14, when the container is empty, etc. Also, a manipulable switch 32 can be provided on the housing 12 as shown to provide a means for user activation of the motorized pump in the event that the motion sensor 23 malfunctions or for initial priming. Additional switches may be used, e.g. for, deactivating the electrical components for cleaning. When the system 10 is first activated, a user can depress the switch 32 to cause a user-desired amount of soap to be expelled from the container 14, at which time the user can release the switch 32. The distance of motion of the motor-driven pump during the time the switch 32 is depressed can be “remembered” by the circuitry shown and described further below so that subsequent soap expulsion in response to signals from the motion sensor will be in the same amount as the first user-defined amount. In the case of the gear and screw pumps, the number of turns or length of time the motor is operated can be “remembered” by the circitry shown and describied further below so that subsequent soap expulsion in response to signals from the motion sensor will be in the same amount as the first user-defined amount. A slider or knob-type control that allows the user to adjust quantity of substance dispensed over a reasonable range may also be provided. As another alternative, the motion detector can cause soap or other materials to be continuously dispensed for as long as the motion sensor allows.

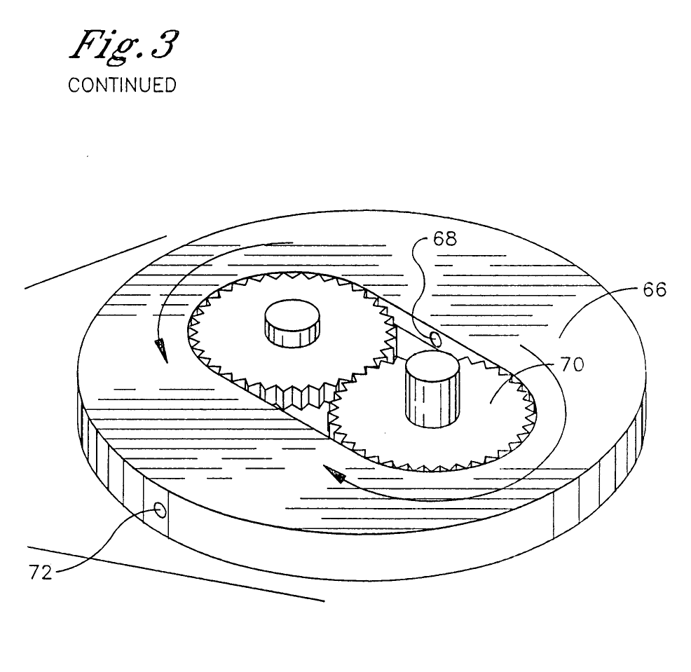

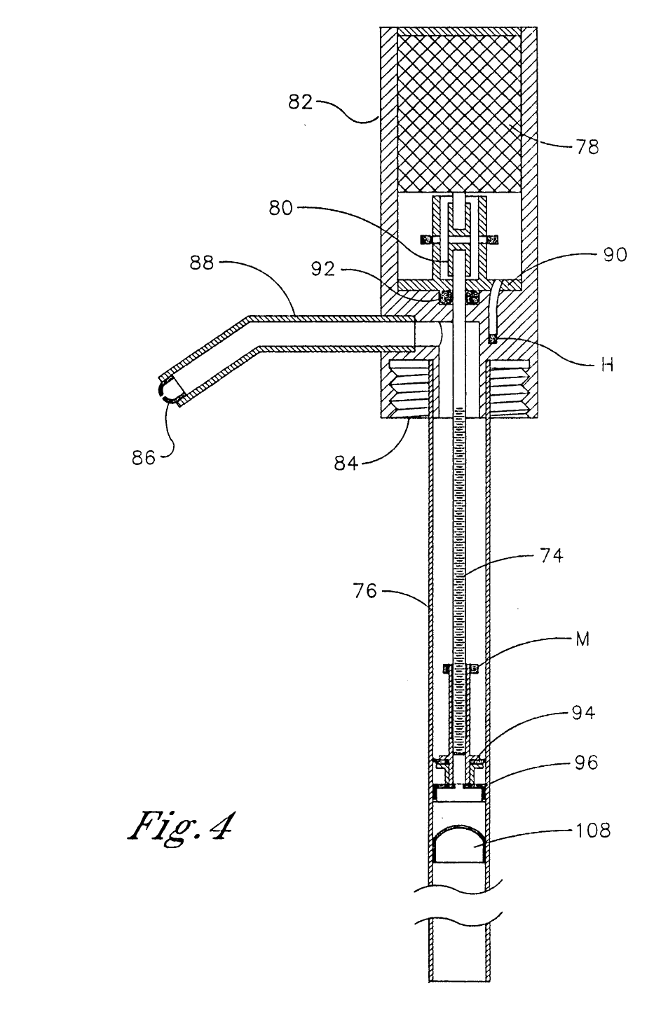

As yet another alternative, a computer chip may be provided, and the user can place his hand under the motion sensor, press a button and hold it until the desired quantity of substance has been dispensed. From thereon that quantity would be dispensed. This concept can be used with the lead screw pump described further below, in which the user may also be permitted to set a specific dispensing quantity per stroke and then set the number of strokes dispensed for each detection cycle. In any case, it is to be understood that for the pump shown in FIGS. 4 and 5, the maximum amount of liquid that can be dispensed per cycle is limited by the cross-sectional area of the tube and length of the delivery stroke.

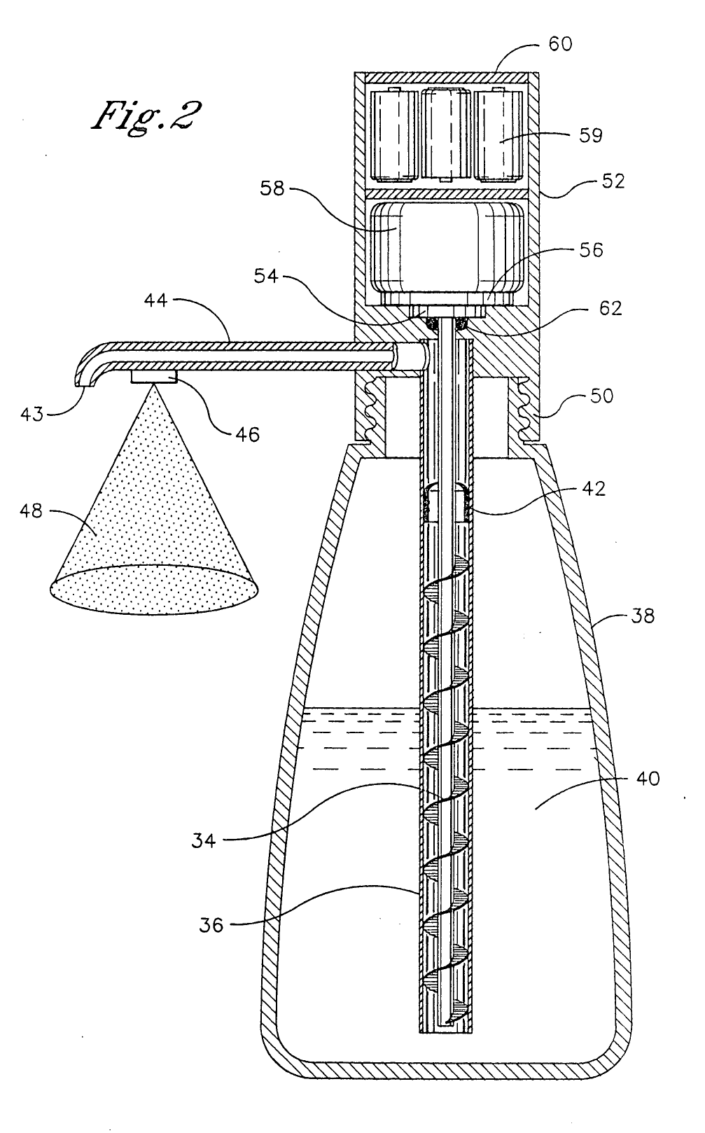

Now referring to FIG. 2, a first embodiment is shown in which a screw pump 34 is rotatably disposed in an uptake tube 36 within a container 38 of substance 40. The screw pump may be replaced by a “Moyno” pump. The substance 40 can be liquid soap and the container 38 can be the conventional container 14 shown in FIG. 1 that is originally associated with a manual pump mechanism. The bottom end of the uptake tube 36, which is closely positioned from the bottom of the container 38, is open, and substance 40 flows into the uptake tube 36. Accordingly, when the screw 34 turns, the action of its threads draws up substance 40 through the uptake tube 36 for expulsion of the substance through the below-described outlet tube.

To ensure that a constant volume of substance 40 is delivered regardless of the level of substance 40 in the container 38, a one-way valve 42 may be disposed in the uptake tube 36 as shown. In one implementation the one-way valve 42 may be a rubber or plastic disk-shaped membrane that has radial slots cut into it to establish flaps. In other implementations, depending on the type of pump used, ball-type check valves or other one-way valves can be used. In still other implementations, the one-way valve 42 may be disposed anywhere between the top of the screw pump 34 and the downwardly-oriented open end 43 of an outlet tube 44, including on the end of the open end 43.

In any case, the vertical uptake tube 36 communicates at its upper end with the horizontal outlet tube 44 that defines an outlet passage and a downward-oriented orifice at the open end 43 through which substance 40 is dispensed. A motion sensor 46 may be disposed as by, e.g., adhesive bonding on a bottom surface of the outlet tube 44 as shown, preferably very close to the downward-oriented open end as shown. The sensor 46 may be disposed elsewhere on or near the housing. In non-limiting implementations, the motion sensor 46, along with associated processing circuitry, establishes a motion detector, and may be embodied by any one of the above-referenced devices. Because it is oriented downwardly, the motion sensor senses hand motion beneath the open end of the outlet tube in a detection cone indicated at 48 in FIG. 2.

Still referring to FIG. 2, in one non-limiting embodiment the screw pump 34 extends up through an engagement collar 50 of a hollow housing 52 to terminate in an upper engagement flange 54. The engagement collar 50 is internally threaded as shown for engaging the male threads of the container 38. The upper engagement flange 54 can be coupled through planetary reduction gears 56 to a motor 58 such as a reversible dc motor. The housing 52 also holds one or more batteries 59 that power the motor and an electronic circuit board 62 that can hold both the motion detector circuitry associated with the motion sensor 46 and control circuitry for controlling the motor 58 (and, hence, the screw pump 34) in response to motion signals from the sensor 46. If desired, an o-ring 62 or other seal can be positioned in the housing 52 beneath the engagement flange 54 to prevent substance 40 from leaking into the housing 52.

In non-limiting implementations, the batteries 59 may be one or more small primary dc batteries that may be, without limitation, type AAA alkaline batteries, and they may come packaged within the housing with peel-off activation tags to prevent them from discharging until the tags are removed. The motion detector system electronics on the circuit board 60 can be electrically connected to a logic device to provide signals representing motion to the logic device. The logic device may be a digital or analog circuit that executes the logic discussed below. It may also be a microprocessor that executes logic in the form of software. The logic may be embodied in hardware or firmware. In other words, the nature of the logic device is not limiting.

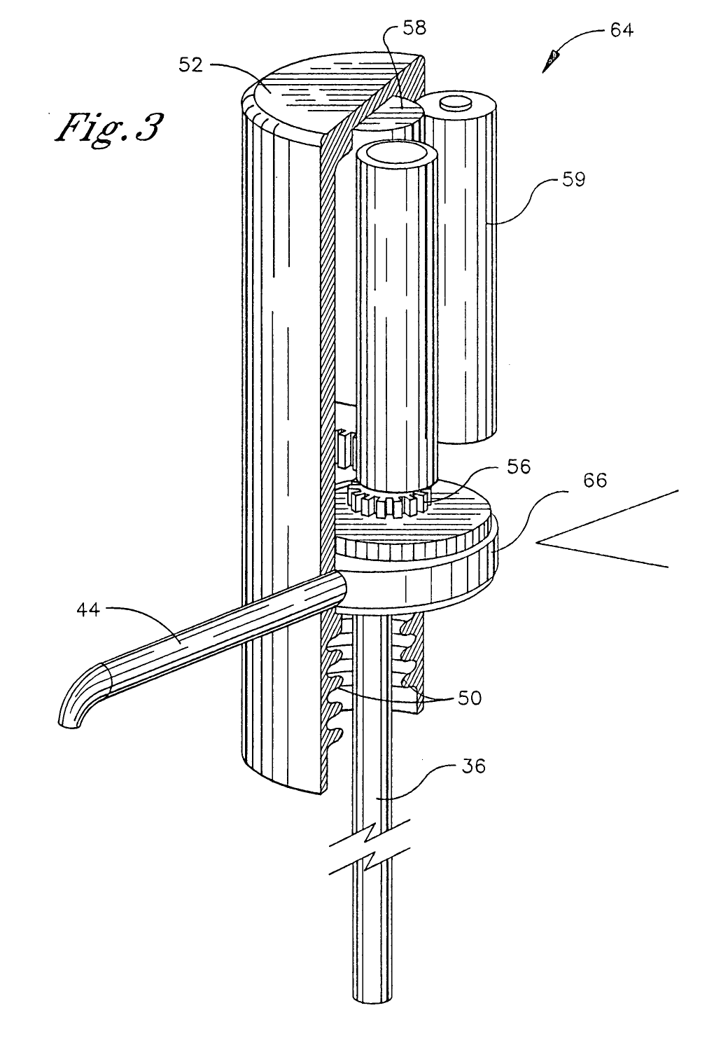

FIG. 3 shows a motion-activated automatic soap dispenser 64 that in all essential respects is substantially identical to the one shown in FIG. 2, with the exception that instead of a screw pump, a gear pump 66 is used as the pumping mechanism. The gear pump 66 has an inlet 68 that fluidly communicates with the uptake tube of the dispenser and plural gear elements 70 that are coupled to reduction gears and thus the motor of the device to turn and expel fluid from an outlet 72 into the outlet tube of the dispenser.

Turning now to FIGS. 4-7, a third type of pumping mechanism is shown which includes a rotatable threaded lead screw disposed in an uptake tube 76. The lead screw 74 is coupled to a motor and optional gear assembly 78 through an appropriate coupler 80, with the coupler, motor, batteries (not shown) and control electronics (not shown) being disposed in a hollow housing 82 that is formed with a lower portion with internal threads 84. As was the case with the previous embodiments, the uptake tube 76 may be disposed in a container of substance such as liquid soap with the threads 84 engaging the male threads of the container. The direction of rotation of the lead screw 74 is determined by the polarity of the motor voltage.

Before turning to the details of the pumping mechanism shown in FIGS. 4-7, FIG. 4 illustrates that in the embodiment shown an orifice 86 may be disposed in an outlet passage formed by an outlet tube 88. The diameter of the orifice 86 is smaller than the diameter of the outlet passage. The orifice 86 may be established by a disk-shaped orifice plate disposed in the outlet tube and formed with an orifice or it may be established by other flow restricting devices known in the art, e.g., a venturi tube. It is to be understood that the orifice can be used in the other embodiments shown herein. The purpose of the orifice is to facilitate high velocity flow of the substance out of the outlet passage, in part so that substance flow can be started and stopped quickly and thus, for instance, lessen dripping of substance out of the outlet passage when the motorized pump is not activated. In alternate embodiments a one-way valve such as the below-described one-way valve 108 or variations thereof can be used in lieu of the orifice 86 to reduce dripping while providing the one-way action required to eliminate back flow when the below-described piston assembly 94 returns to its ready position. FIG. 4 also shows that if desired, the lead screw 74 extends into the housing 82 and passes through an o-ring seal plate 90, beneath which an o-ring 92 or other seal may be disposed for purposes disclosed above. As was the case with the orifice, the seal plate and o-ring combination shown in the lead screw embodiment may also be used in the screw pump and gear pump implementations.

Returning to the pumping mechanism shown in FIGS. 4-7, a piston assembly 94 is threadably engaged with the lead screw 74 so that it rides translationally up or down on the lead screw 74 when the lead screw 74 rotates. In other words, as the lead screw 74 is turned clockwise and then counterclockwise the piston assembly 94 linearly reciprocates between a ready configuration (FIG. 4), wherein when no motion signal is received the piston assembly 94 is detached from the lead screw 74, and a delivery configuration (FIG. 5). In a non-limiting implementation a return spring 96 is provided in the uptake tube 76 for purposes to be shortly disclosed, and the return spring 96 is compressed by the piston assembly 94 in the ready configuration. When a motion signal is received and the piston assembly 94 is in the ready configuration, the lead screw 74 starts rotating, and the piston assembly 74, under urging from the return spring 96, is reengaged with the lead screw 74 so that it rides up the lead screw 74 to the delivery configuration.

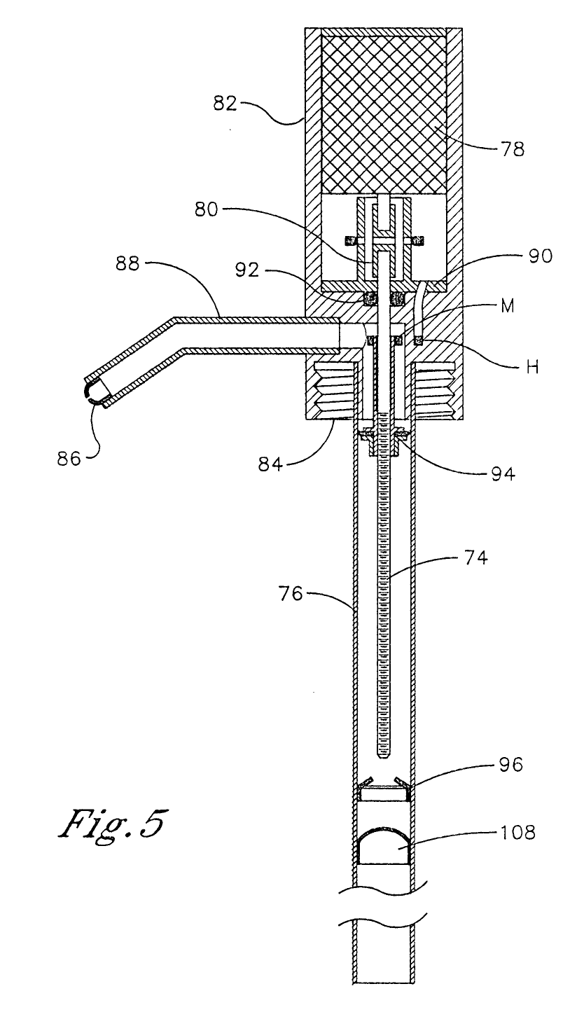

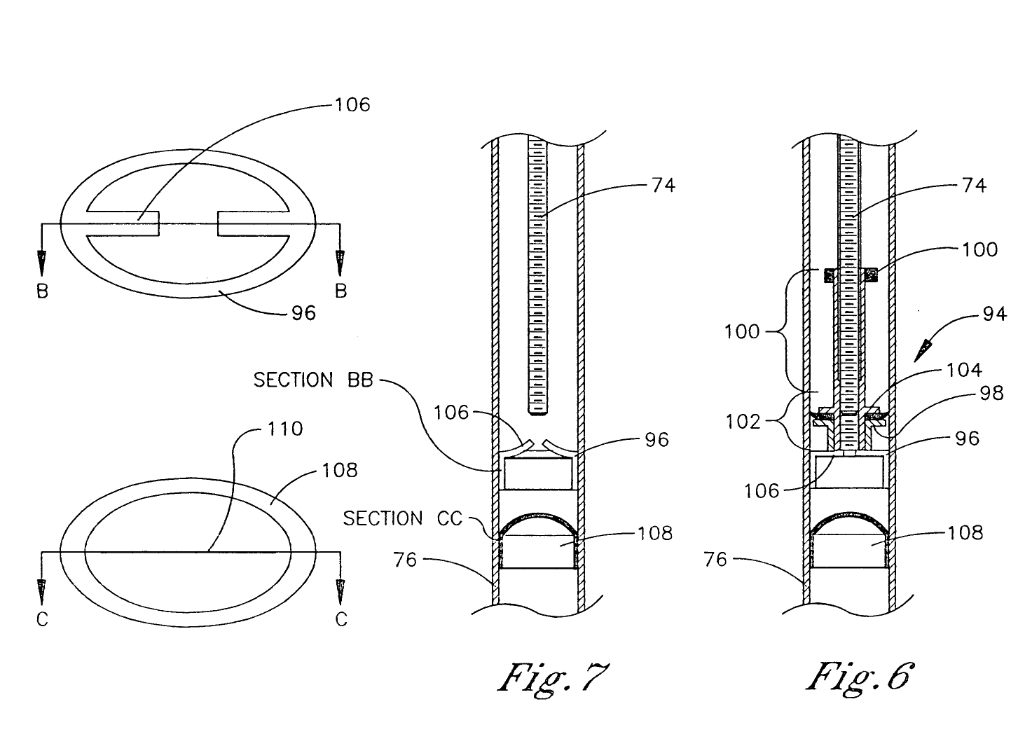

The above operation can be better understood in reference to the details of FIGS. 6 and 7, which respectively show the piston assembly in the ready and delivery configurations. The piston assembly 94 includes a piston 98 that has the same cross-section as the uptake tube 76 and that rides against the walls of the uptake tube 76. Also, the piston assembly 94 has a hollow lead screw engagement member which includes an upper non-threaded guide portion 100 for closely surrounding the lead screw 74 and a lower internally threaded section 102 for threadably engaging the lead screw 74. A piston support flange 104 may be formed between the non-threaded and threaded portions 100, 102, with the piston 98 being disposed against the lower surface of the flange 104 in a closely surrounding relationship with the threaded section 102. The piston 98 may be made integrally with the lead screw engagement member or it may be made separately and then engaged with the lead screw engagement member in an interference fit and/or using adhesive bonding or other attachment means, e.g., ultrasonic welding, brazing, etc. Although not shown, for the sake of clarity, the piston assembly may also include a one-way valve similar to the other one-way valves shown in the various uptake tubes, for purposes to be disclosed below.

The return spring 96, in one non-limiting implementation, is formed with generally horizontal movable fingers 106 which are biased upwardly as shown in FIG. 7 and which are compressed down to a horizontal orientation by the piston assembly 94 as shown in FIG. 6 when the lead screw 74 returns the piston assembly to the ready configuration. “Section BB” to the left of FIG. 7 shows that the ends of the fingers 106 are spaced apart from each other and may be diametrically opposed to each other. To establish the ready configuration, the piston assembly 94 runs off the end of the lead screw 74 just before the lead screw stops rotating and thus is threadably disengaged from the lead screw 74. As shown, however, the threaded section 102 remains very close to the lead screw 74 and is constantly urged against the lead screw by the return spring 96. Consequently, when the lead screw starts rotating again, the piston assembly reengages the lead screw 74 and starts to ride up toward the delivery configuration. If desired, a one-way valve 108 may be provided in the uptake tube 76. In a non-limiting implementation the one-way valve 108 can be a duckbill type valve that has a central diametric slit 110 formed in it as shown in “Section CC” shown just to the left of FIG. 7.

With the above structural disclosure in mind, the purpose of the return spring operation described above is to ensure that the piston assembly is always re-positioned after substance delivery to the same starting location despite any variations that might occur in motor and/or battery voltages, etc. over time, to ensure that the lead screw doesn't become displaced from an absolute starting point. It is to be understood that in the embodiments shown thus far, the amount of substance delivered is controlled by operating the pump motor for a fixed period of time. As recognized herein, as the batteries deplete, the rate of rotation of the motor decreases and consequently less substance is delivered per cycle, at which time the user can adjust the amount of substance delivered in accordance with above principles.

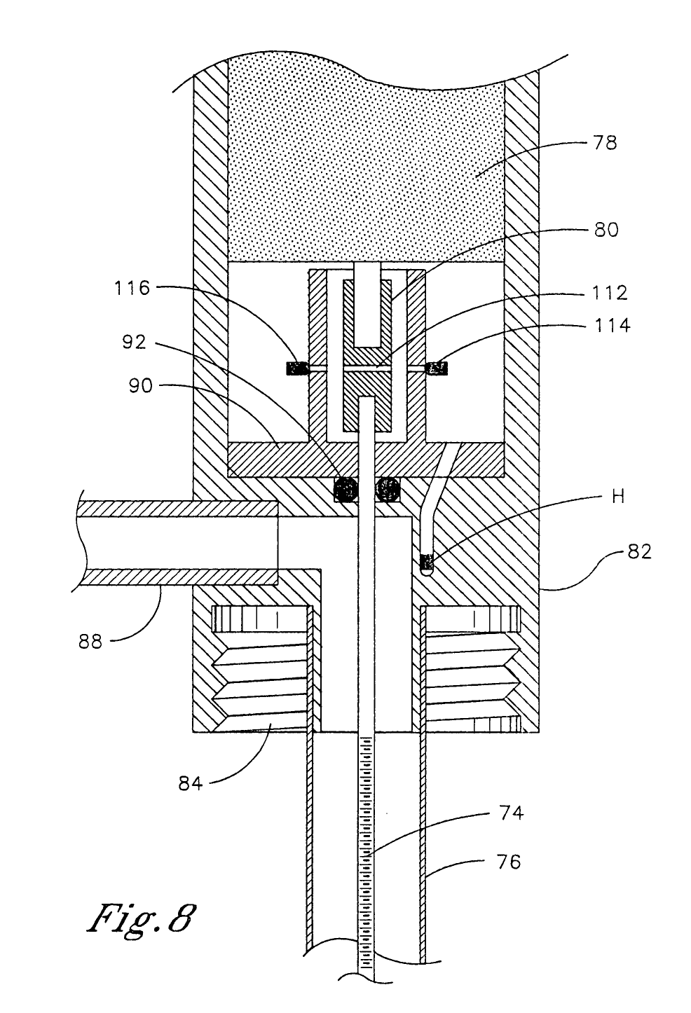

In lieu of a mechanical solution, as recognized herein the electrical circuitry of the present invention may include count circuitry to count pulses as the motor turns and to stop the pumping assembly at the same count value each time. For instance, as shown in FIG. 4 a magnet “M” can be placed on a suitable location of the motorized pump assembly to rotate therewith, with a stationary sensor such as a Hall effect sensor “H” (FIGS. 4 and 8, shown mounted in the housing 82 at the same height as the outlet tube 88) sensing magnetic pulses as the magnet rotates past. Equivalently, the sensor can rotate and the magnet can be fixed. Because the position of the piston assembly 94 can always be determined absolutely with the Hall effect sensor “H” and magnet “M” and because the absolute number of rotations of the pumping assembly can be counted, the electronic circuitry can power the pump for an absolute number of rotations of the threaded lead screw 74 independent of the rate at which the threaded lead screw 74 rotates.

Yet again, as best shown in FIG. 8 in lieu of or in addition to the Hall effect sensor, in some non-limiting embodiments a hole 112 can be made laterally through the coupler 80 and a light emitter 114 and light detector 116 can be placed such that two light pulses can be counted for each rotation of the threaded lead screw 74 (or its equivalents in other embodiments).

To prevent the piston assembly from rotating when the lead screw turns, the uptake tube 76, piston 98, return spring 96, and one-way valve 108 may have non-circular cross-sections, for instance, oval as shown. Or the cross-sections may be rectilinear, or the cross-sections may be circular, in which case a rail or other guide member must be provided in the uptake tube 76 to engage complementary structure on the piston assembly to prevent it from rotating.

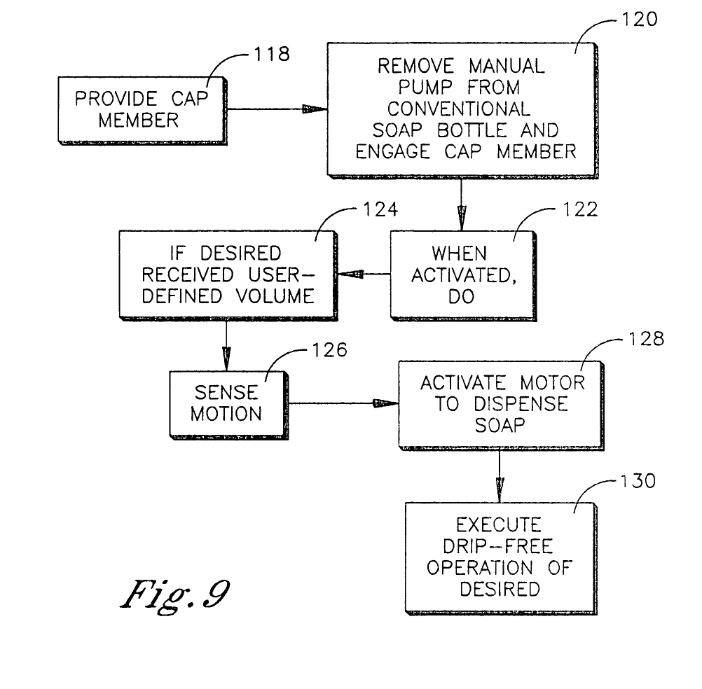

Regardless of the particular configuration of the pumping mechanism, FIG. 9 illustrates logic that may be employed at least in relevant part by the logic in the electronic circuitry of the present invention. Commencing at block 118, the cap member such as one of the housings shown herein that contain a motorized motion-driven dispensing system of the present invention is provided. At block 120, the manual pump mechanism 16 (or often closure, such as a threaded cap) shown in FIG. 1 may be removed from the conventional container 14 and replaced by the present motorized cap member. When the cap member is activated at block 122 and the pump assembly is in a position such as the ready configuration in the case of the lead screw embodiment to deliver substance, the logic moves to block 124 if desired to receive the aforementioned user-defined pumping element volume amount. Then, at block 126, the logic determines when motion has been sensed. Any suitable signal from the motion detector system may be interpreted by the logic as indicating motion, or only motion signals indicating a degree of motion above a threshold might result in a motion detection indication being interpreted by the logic.

Proceeding to block 128 when a motion signal is interpreted by the logic to indicate motion, the motor is energized to activate the pumping mechanism and thus to dispense the substance, e.g., liquid soap or toothpaste or mouthwash. Thus, when a user puts his hand under the dispensing spout, the motion detector initiates a fixed volume of substance dispensing cycle. Until the user's hand is removed and placed under the spout again, no further substance is dispensed.

It will be readily appreciated that the length of the delivery stroke of the positive displacement pumps shown herein can be controlled by how long the motor is operated. The pump assemblies shown herein thus have a position in which they are ready to deliver substance, e.g., the ready configuration of FIG. 4, and a position in which they are at the end of the delivery cycle, e.g., the delivery configuration shown in FIG. 5. When voltage of the proper polarity is applied to the motor the pumping mechanism moves in a delivery stroke during which the associated one way valve in the uptake tube opens, allowing fluid to enter the bottom of the uptake tube. In the lead screw embodiment shown in FIGS. 4-8, the aforementioned one-way valve in the piston assembly remains closed during the delivery cycle; thus liquid is forced out of the outlet tube. The screw and gear pump embodiments have no need of motor reversal.

Once the delivery stroke is completed, the motor voltage is reversed to return the pumping mechanism to the ready configuration. For the implementation shown in FIGS. 4-8, during the time the piston assembly is traveling downward toward the one way valve 108 in the uptake tube 76, the one way valve 108 is closed and the one-way valve in the piston assembly is open.

At block 130 a drip-free operation may be initiated. This drip-free operation can include quickly reversing the motor voltage and thus pump direction immediately after reaching the dispensing configuration to essentially slightly suck back into the outlet tube any residual substance, to prevent the residual substance from dripping. To this end, the one-way valve of the present invention may retain sufficient hysteresis to assist in this operation.

The embodiments disclosed above afford advantages including the use of low power. For example, the standby current for most existing motion sensors is at least one hundred microamps and more typically is two hundred microamps, requiring at least eight amp-seconds of energy per day for detection only, regardless of the amount of soap dispensed. Using the preferred sensors disclosed above, in contrast, results in daily standby current power of less than 1.2 amp-seconds, allowing, among other things, the use of much smaller batteries. This in turn facilitates product options not possible with conventional designs, such as mounting the dispensing system directly on top of the retail containers for substances such as liquid soap, hand creams or toothpaste.

Further, the use of the extrusion screw and lead screw design concepts disclosed above are very simple, require low tolerance parts and lend themselves efficiently to a battery-powered container top replacement that provides hand detection along with liquid and dispensing means. Further still, the embodiments disclosed herein permit a range of user-adjustable dispensing volumes.

In non-limiting implementations, to prime the pump when first installed, several seconds or cycles of operation may be required. As a convenience and as mentioned above, a manual control (pushbutton, membrane switch, etc.) may be added. This control will operate the screw or gear pumps continuously until the operator stops activating the control, which may be preferable to continuously placing and removing one's hand under the dispensing spout until the unit is primed.

In the case of the lead screw pump, liquid is delivered in spurts of discrete volumes. The manual pump control causes this pump to deliver continuous spurts until the operator stops activating the control.

As also mentioned above, an on/off control may be provided to allow the user, e.g. to move or clean the container, without triggering a release of substance. This feature can be implemented in the form of a “kill button” that keeps the unit deactivated as long as the button is depressed, or as a button that, when momentarily pushed, deactivates the dispenser for a given period of time, e.g., fifteen to sixty seconds.

While the particular MOTION-ACTIVATED SOAP DISPENSER as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. For instance, in addition to the pump types described above, reciprocating piston pumps, peristaltic pumps, crank shaft pumps, turbine pumps, and electroactive polymer “artificial muscles” can be used. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

What is claimed is:

1. An automatic soap dispensing system, comprising:
a hollow housing configured for threadably engaging a soap container, wherein the container for which the housing is configured is a container originally associated with a manual pump mechanism for expelling soap therefrom;
at least one battery in the housing;
a motion detector powered by the battery; and
at least one motorized pump assembly in the housing and powered by the battery, the pump assembly expelling soap from the container in response to signals from the motion detector.

2. The system of claim 1, wherein the motion detector is a passive infrared (PIR) detector.

3. The system of claim 2, wherein the motion detector never consumes more than fifty microamperes.

4. The system of claim 1, wherein the pump assembly comprises an outlet passage and an orifice in the outlet passage.

5. The system of claim 1, wherein the pump assembly comprises an uptake tube extending into the container when the housing is engaged therewith, the uptake tube including a one-way valve disposed therein.

6. The system of claim 1, wherein the pump assembly includes a screw pump member rotating to draw up substance along the threads of the screw pump from an uptake tube, the substance being urged into an outlet passage.

7. The system of claim 1, wherein the pump assembly includes a gear pump.

8. The system of claim 1, wherein the pump assembly includes a rotatable lead screw and a piston reciprocatingly engaged therewith for linear motion when the lead screw rotates.

9. The system of claim 8, wherein the pump assembly moves between a ready configuration, wherein no motion signal is received and the piston is detached from the lead screw and compresses a return spring, and a delivery configuration, wherein the piston is engaged with the lead screw, the presence of a motion signal when in the ready configuration causing the lead screw to rotate with the return spring urging the piston into engagement with the lead screw as it rotates for movement to the delivery configuration.

10. An automatic substance dispensing system, comprising:
a hollow housing configured for removably engaging a substance container;
at least one battery in the housing;
a PIR motion detector and powered by the battery, wherein the motion detector never consumes more than an average of fifty microamperes; and
at least one motorized pump assembly in the housing and powered by the battery, the pump assembly expelling substance from the container in response to signals from the motion detector.

11. The system of claim 10, wherein the container is a soap container and the housing is configured for threadably engaging the container.

12. The system of claim 10, wherein the pump assembly comprises an outlet passage and an orifice in the outlet passage.

13. The system of claim 10, wherein the pump assembly comprises an uptake tube extending into the container when the housing is engaged therewith, the uptake tube including a one-way valve disposed therein.

14. The system of claim 10, wherein the pump assembly includes a screw pump member rotating to draw up substance along the threads of the screw pump from an uptake tube, the substance being urged into an outlet passage.

15. The system of claim 10, wherein the pump assembly includes a gear pump.

16. The system of claim 10, wherein the pump assembly includes a rotatable lead screw and a piston reciprocatingly engaged therewith for linear motion when the lead screw rotates.

17. The system of claim 16, wherein the pump assembly moves between a ready configuration, wherein no motion signal is received and the piston is detached from the lead screw and compresses a return spring, and a delivery configuration, wherein the piston is engaged with the lead screw, the presence of a motion signal when in the ready configuration causing the lead screw to rotate with the return spring urging the piston into engagement with the lead screw as it rotates for movement to the delivery configuration.

18. A method comprising:
disposing a motion detector and a motorized pump in a housing;
removing a manual pump mechanism from a substance container;
engaging the housing with the container; and
activating the pump in response to signals from the motion detector to expel substance from the container.

19. A method comprising:
disposing a motion detector and a motorized pump in a housing;
removing a container closing mechanism from a substance container; and
engaging the housing with the container.

20. The method of claim 19, comprising vending the housing without a substance container.

21. An automatic household liquid dispensing system, comprising:
a hollow housing configured for engaging a soap container, wherein the container for which the housing is configured is a container having a removable closure;
at least one battery in the housing;
a motion detector in the housing and powered by the battery; and
at least one motorized pump assembly in the housing and powered by the battery, the pump assembly expelling soap from the container in response to signals from the motion detector.

22. An automatic household liquid dispensing system, comprising:
a hollow housing configured for engaging a soap container, wherein the container for which the housing is configured is a container having a removable closure;
at least one battery in the housing;
a motion detector and powered by the battery; and
at least one motorized lead screw assembly in the housing and powered by the battery, the lead screw assembly expelling soap from the container in response to signals from the motion detector.

23. The system of claim 10, wherein a tube for withdrawal of liquid extends downward from the housing to the bottom of the container for drawing liquid from the container.

24. The system of claim 10, wherein the container is rigid and the housing is on the top of the container.

25. The system of claim 10, wherein the container is flexible.

26. An automatic substance dispensing system, comprising:
a hollow housing configured for removably engaging a substance container wherein a substance container closure is on the top of the container;
at least one battery in the housing;
a PIR motion detector;
a motorized pump assembly in the housing and powered by the battery, a tube for withdrawl of substance, the tube extending downward from the container closure to the bottom of the container for drawing liquid from the container,
the pump assembly expelling substance from the container in response to signals from the motion detector.
